(19) United States
(12) Patent Application Publication
(10) Pub. No.: US 2016/0362299 A1
(43) Pub. Date: Dec. 15, 2016

(54) CARBON NANOTUBE FOREST LAMINATED BODY AND METHOD OF PRODUCING CARBON NANOTUBE FOREST LAMINATED BODY

(71) Applicant: LINTEC OF AMERICA, INC., Phoenix, AZ (US)

(72) Inventors: KANZAN INOUE, Phoenix, AZ (US); MASAHARU ITO, Phoenix, AZ (US); CHI HUYNH, Phoenix, AZ (US)

(73) Assignee: LINTEC OF AMERICA, INC., Phoenix, AZ (US)

(21) Appl. No.: 15/179,059

(22) Filed: Jun. 10, 2016

Related U.S. Application Data
(60) Provisional application No. 62/175,061, filed on Jun. 12, 2015.

(51) Int. Cl. C01B 31/02; B32B 37/12; B32B 37/24

(52) U.S. Cl. CPC C01B 31/0253; B32B 37/24; B32B 37/12; B82Y 40/00

(57) ABSTRACT

It is an object of the present invention to provide a carbon nanotube forest laminated body that enables easy production of a carbon nanotube sheet from a carbon nanotube forest and a method of producing a carbon nanotube forest laminated body. The carbon nanotube forest laminated body of the present invention includes a support having an adhesive (sticky) surface and a carbon nanotube forest provided on the surface of the support. The surface of the support has an adhesive strength of 0.01 N/25 mm or more and 2 N/25 mm or less, and the carbon nanotube forest is provided on the surface.

### RELATED APPLICATIONS

This application claims benefit of U.S. Provisional Application Serial No. 62/175,061 filed Jun. 12, 2015, the contents of which are incorporated by reference herein.

### FIELD OF THE INVENTION

The present application relates to a carbon nanotube forest laminated body and a method of producing a carbon nanotube forest laminated body, and more specifically, relates to a carbon nanotube forest laminated body that enables suitable drawing of a carbon nanotube sheet from a carbon nanotube forest and a method of producing a carbon nanotube forest laminated body.

### BACKGROUND

Sheets and ribbons can be made from nanofibers such as carbon nanotubes. Carbon nanotube forests can be grown on a substrate via chemical vapor deposition (CVD) and can be drawn into lengths of sheets or ribbons from the carbon nanotube forest. The resulting sheets and ribbons can be extremely thin and exhibit unique electrical properties as well as great strength.

### SUMMARY

In one aspect, a carbon nanotube forest laminated body is provided, the carbon nanotube forest laminated body comprising a support having an adhesive surface and a carbon nanotube forest provided on the surface of the support, the surface of the support having an adhesive strength of greater than or equal to 0.01 N/25 mm and less than or equal to 2 N/25 mm. The support can be a self-adhesive sheet or a base material coated or laminated with an adhesive. The support can be a resin film. The adhesive strength of the support and the forest can be greater than the adhesive force between the forest and the growth substrate on which the carbon nanotube forest was grown. In some embodiments, the forest has a proximal surface which was formerly in contact with a growth substrate and a distal surface which was opposed to the surface of the growth substrate, and the proximal surface is attached to the adhesive surface. In other embodiments, the forest has a proximal surface which was formerly in contact with a growth substrate and a distal surface which was opposed to the surface of the growth substrate, and the distal surface is attached to the adhesive surface. The laminated body may be covered by a release sheet on top of the forest. In further embodiments, a carbon nanotube sheet is drawn from the carbon nanotube forest laminated body.

In another aspect, a method of producing a carbon nanotube forest is provided, the method comprising shifting a carbon nanotube forest from a substrate on which the carbon nanotube forest is provided onto a surface of a support, the surface having an adhesive strength of 0.01 N/25 mm or more and 2 N/25 mm or less. In some embodiments, the surface has an adhesive strength of greater than or equal to 0.015 N/25 mm, greater than or equal to 0.025 N/25 mm, greater than or equal to 0.04 N/25 mm or greater than or equal to 0.05 N/25 mm. In some embodiments, the forest has a proximal surface that is in contact with substrate prior to shifting and is in contact with the support after shifting. In other embodiments, the forest has a proximal surface that is in contact with substrate prior to shifting and an opposed distal surface that is in contact with the support after shifting. Carbon nanotube sheets, ribbons and yarns can be drawn from the forest. In some embodiments, a release sheet is placed on top of the forest and the laminated body can be transported and used at a remote location.

### BRIEF DESCRIPTION OF THE DRAWING

FIG. 1A is a schematic cross sectional diagram of a carbon nanotube forest laminated body according to an embodiment of the present invention.

FIG. 1B is a schematic cross sectional diagram of a carbon nanotube forest laminated body according to an embodiment of the present invention.

FIG. 2A is a diagram illustrating an example method of producing a carbon nanotube forest laminated body according to an embodiment of the present invention.

FIG. 2B is a diagram illustrating an example method of producing a carbon nanotube forest laminated body according to an embodiment of the present invention.

FIG. 3A is a diagram illustrating another example method of producing a carbon nanotube forest laminated body according to an embodiment of the present invention.

FIG. 3B is a diagram illustrating another example method of producing a carbon nanotube forest laminated body according to an embodiment of the present invention.

FIG. 4A illustrates schematically a cross sectional view of a carbon nanotube forest laminated body.

FIG. 4B illustrates schematically a cross sectional view of forest and substrate of

FIG. 4A with a portion of the substrate bent away to expose a portion of the forest.

FIG. 4C illustrates schematically a cross sectional view of the carbon nanotube forest of FIG. 4A being transferred from a growth substrate to a polymer substrate.

FIG. 4D illustrates schematically a cross sectional view of the carbon nanotube forest of FIG. 4 being completely transferred to a polymer substrate.

FIG. 5 provides a schematic view of an embodiment nanofiber forest laminated body on a secondary substrate with the forest covered by a release sheet.

### DETAILED DESCRIPTION

Methods have been developed for producing carbon sheets from carbon nanotubes grown in a forest. For example, Japanese Patent No. 5350635 describes a method of producing a carbon nanotube sheet in which carbon nanotubes grown on a substrate by chemical vapor deposition (CVD) are drawn with a jig, and then the drawn ribbon-like carbon nanotubes are disposed on a film to form a carbon nanotube sheet. Next, the carbon nanotube sheet with the film is impregnated with acetone or a similar solvent to be densified. This treatment modifies the carbon nanotube sheet to have higher strength and higher light transmission factor.

However, when the method of producing a carbon nanotube sheet described in Japanese Patent No. 5350635 is used, the carbon nanotube forest often either separates from the substrate or is not easily drawn from the carbon nanotube forest due to the interaction between the substrate and the carbon nanotube forest provided on the substrate. The methods describe herein provide for carbon nanotube forests that do not separate from the substrate prematurely and are still readily drawable to form sheets, yarns and ribbons.

Embodiments of the present invention will now be described in detail with reference to the attached drawings. The present invention is not limited to the following embodiments, which can be appropriately changed for carrying out the invention. The following embodiments can be appropriately combined for carrying out the invention. Components common in the following embodiments are indicated by the same signs, and are not repeatedly described.

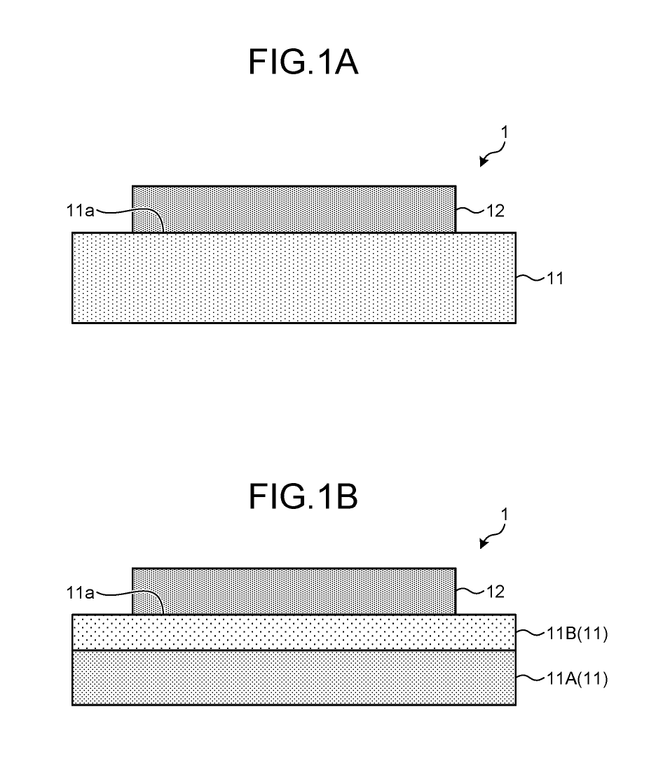

FIG. 1A and FIG. 1B are schematic cross sectional diagrams of carbon nanotube (CNT) forest laminated bodies according to two embodiments of the present invention. The CNTs can be multi-walled carbon nanotubes (MWCNT) or single-walled carbon nanotubes (SWCNT). As illustrated in FIG. 1A, a carbon nanotube forest laminated body 1 according to the present embodiment includes a support 11 with an adhesive (sticky) surface 11a and a carbon nanotube forest 12 provided on the surface 11a of the support 11. The carbon nanotube forest laminated body 1 is used to produce a carbon nanotube sheet by drawing a carbon nanotube sheet from the carbon nanotube forest 12 provided on the support 11.

Surface 11a facing the carbon nanotube forest 12 has an adhesive strength of greater than or equal to 0.01 N/25 mm and less than or equal to 2.0 N/25 mm, which can be determined using any method known in the art, such as in accordance with JIS Z0237:2000. This range makes the support 11 have an appropriate adhesive strength range with respect to the carbon nanotube forest 12, and thus a carbon nanotube sheet can be easily drawn from the carbon nanotube forest 12 supported on the support 11 while the carbon nanotube forest 12 is prevented from prematurely separating from the support 11. When a carbon nanotube forest is prone to premature separation from the substrate, the laminate is difficult to store and transport without damaging the forest. Furthermore, gas is often flowed across the forest in order to prevent dust from adhering, or to remove attached dust after the formation of the carbon nanotube forest 12. Weakly attached nanotubes can be unintentionally removed as a result of this process.

In the example illustrated in FIG. 1A, the support 11 is a self-adhesive sheet having a surface Ila facing the carbon nanotube forest 12, and the surface Ila has an adhesive strength of between 0.01 N/25 mm and 2 N/25 mm determined, for example, in accordance with JIS Z0237:2000. Here, the self-adhesive sheet is an adhesive sheet having a surface to which the carbon nanotube forest 12 can adhere by means of the adhesiveness of the sheet itself without requiring any adhesive or other means.

In one set of embodiments, the thickness of the support 11 composed of the self-adhesive sheet is greater than or equal to 10 μm and less than or equal to 400 μm in order to easily draw a carbon nanotube sheet from the carbon nanotube forest 12 supported on the support 11 while simultaneously preventing part or all of the carbon nanotube forest 12 from separating prematurely from the support 11. Support 11 can be flexible allowing the nanotube forest laminated body to be rolled up or attached to curved surfaces.

The thickness (height) of the carbon nanotube forest 12 can be, for example, greater than or equal to 20 μm and less than or equal to 1,500 μm in order to provide for efficient drawing of a carbon nanotube sheet and to prevent the carbon nanotube forest 12 from separating prematurely from the support 11.

In the example illustrated in FIG. 1B, the support 11 includes a base material 11A and an adhesive layer 11B provided on the base material 11A. Base material 11A need not be adhesive itself. The carbon nanotube forest 12 is provided on a surface 11a of the adhesive layer 11B. Base material 11A can be permanently or temporarily attached to adhesive layer 11B. In the support 11, the surface 11a of the adhesive layer 11B facing the carbon nanotube forest 12 has an adhesive strength of greater than or equal to 0.01 N/25 mm and less than or equal to 2 N/25 mm determined, for example, in accordance with JIS Z0237:2000. In embodiments where the surface 11a of the support 11 has an adhesive strength within this range due to adhesive layer 11B, a carbon nanotube sheet can be easily drawn from the support 11 in a manner similar to that illustrated in FIG. 1A.

In specific embodiments, the adhesive strength of support 11 is greater than or equal to 0.015 N/25 mm, greater than or equal to 0.025 N/25 mm, greater than or equal to 0.04 N/25 mm, greater than or equal to 0.05 N/25 mm and may be less than or equal to 1.5 N/25 mm, less than or equal to 1 N/25 mm, less than or equal to 0.5 N/25 mm, or less than or equal to 0.3 N/25 mm to allow for efficient drawing of a carbon nanotube sheet while also preventing the carbon nanotube forest 12 from prematurely separating from the adhesive. In particular embodiments, the adhesive strength of the support 11 is greater than or equal to 0.015 N/25 mm and less than or equal to 1.5 N/25 mm, greater than or equal to 0.025 N/25 mm and less than or equal to 1 N/25 mm or greater than or equal to 0.04 N/25 mm and less than or equal to 0.5 N/25 mm or greater than or equal to 0.05 N/25 mm and less than or equal to 0.3 N/25 mm.

The base material 11A can be flexible or rigid and may be, for example, a plastic film, paper, a metal foil, or a glass film, for example. Examples of the plastic film include films of polyesters such as polyethylene terephthalate (PET), polybutylene terephthalate, and polyethylene naphthalate (PEN), polyethylene films, polypropylene films, cellophanes, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyethersulfone films, polyetherimide films, polyimide films, fluorine resin films, polyamide films, acrylic resin films, norbornene resin films, and cycloolefin resin films. The inventors have found that films of polyester resins such as polyethylene terephthalate (PET) and films of polyolefin resins such as polyethylene perform well in cases where the substrate is to be cut into multiple pieces while avoiding excessive formation of dust.

The thickness of the base material 11A can be greater than or equal to 10 μm and less than or equal to 300 μm to provide for smooth drawing of a carbon nanotube sheet from the carbon nanotube forest 12 supported on the support 11 and to prevent the carbon nanotube forest 12 from separating prematurely from the support 11.

The adhesive layer 11B may be any layer that can support the carbon nanotube forest 12 and can be formed, for example, by using an adhesive such as rubber adhesives, acrylic adhesives, silicone adhesives, and polyvinyl ether adhesives. In one embodiment, the adhesive layer 11B can be an acrylic adhesive. Acrylic polymers exhibit a higher glass transition temperature and can include a high concentration of crosslinking agents that can allow the practitioner to adjust the adhesive strength of the layer.

The thickness of the adhesive layer 11B is preferably 1 μm or more and 90 μm or less in order to easily draw a carbon nanotube sheet from the carbon nanotube forest 12 supported on the support 11 and to prevent nanofibers from the carbon nanotube forest 12 from separating from the support 11.

Next, a method of producing a carbon nanotube forest laminated body according to an embodiment of the present invention will be described. The method of producing a carbon nanotube forest laminated body according to the present embodiment includes a step of shifting the carbon nanotube forest 12 provided on the substrate by chemical vapor deposition (the growth substrate), or another process, onto the surface 11a of the support 11 having an adhesive strength of 0.01 N/25 mm or more and 2 N/25 mm or less determined, for example, in accordance with JIS Z0237:2000. In some methods, the surface of the forest in contact with the formation substrate (proximal surface) is shifted to contact the adhesive sheet or layer. In other methods, the surface of the forest opposite the formation substrate (distal surface) is contacted with the adhesive sheet or layer.

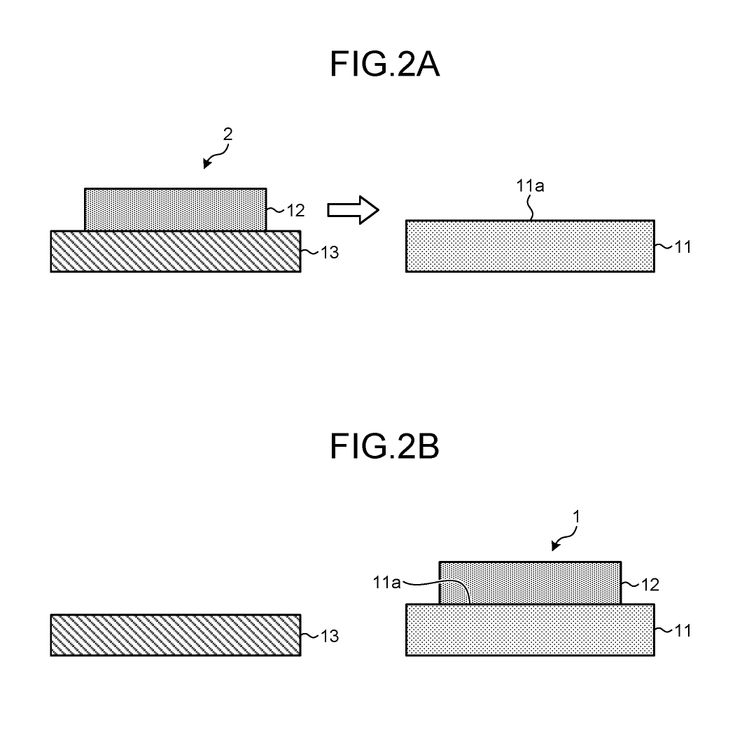

FIG. 2A and FIG. 2B are diagrams illustrating an example method of producing a carbon nanotube forest laminated body according to an embodiment of the present invention. In this example, support 11 is a self-adhesive sheet (film), but the carbon nanotube forest laminated body 1 can be similarly produced in the case in which support 11 is a laminated body of the base material 11A and the adhesive layer 11B illustrated in FIG. 1B.

As illustrated in FIG. 2A and FIG. 2B, laminated body 2 includes the carbon nanotube forest 12 grown on substrate 13 by chemical vapor deposition, or another process, is peeled off from an end of the substrate 13 and then is transferred onto the surface 11a of the support 11. Surface 11a of the support 11 has a predetermined adhesive strength, and thus the carbon nanotube forest 12 can be prevented from releasing from the support 11. In addition, the carbon nanotube forest 12 can be made into an intended size by slicing or cutting the substrate. By transferring the carbon nanotube forest 12 in this manner, the proximal surface of the carbon nanotube forest 12 in contact with the substrate 13 in a single step can become the surface in contact with the surface 11a of the support 11.

In the method illustrated in FIG. 2A and FIG. 2B, the substrate 13 on which the carbon nanotube forest 12 is grown can be a flexible metal substrate, for example. The use of such a metal substrate facilitates efficient shifting of the carbon nanotube forest 12 onto the support 11 because the metal substrate can be bent to peel off the carbon nanotube forest 12 from an end of the metal substrate, and the carbon nanotube forest 12 can be shifted onto the support 11.

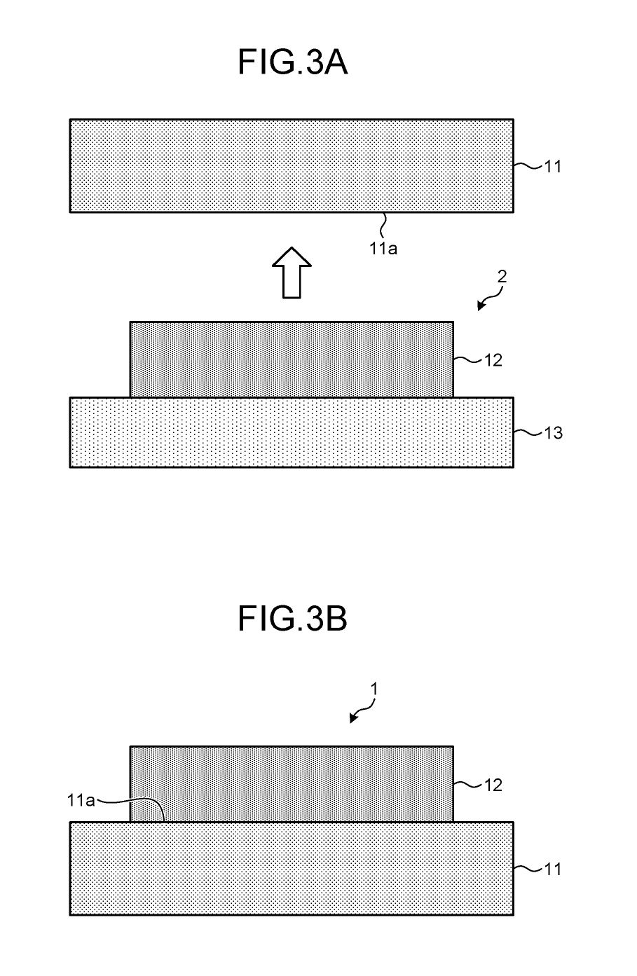

FIG. 3A and FIG. 3B are diagrams illustrating another exemplary method of producing a carbon nanotube forest laminated body according to one embodiment. In this example, the support 11 of the carbon nanotube forest laminated body 1 is a self-adhesive sheet (film) as illustrated in FIG. 1A, but the carbon nanotube forest can be similarly produced on a support 11 comprising an adhesive sheet of the base material 11A and the adhesive layer 11B illustrated in FIG. 1B.

A method of production is illustrated in FIG. 3A and FIG. 3B in which support 11 is brought into contact with the carbon nanotube forest 12 that has been grown on the growth substrate 13 by chemical vapor deposition (CVD) or another process. The carbon nanotube forest 12 is peeled off from the substrate 13 due to the adhesiveness of the support 11 and is shifted onto the surface 11a of the support 11. This step shifts the carbon nanotube forest 12 from the substrate 13 onto the surface Ila (having a predetermined adhesive strength) of the support 11, and thus the carbon nanotube forest 12 can be prevented from separating from the support 11. In addition, the carbon nanotube forest 12 can be divided into different sizes and shapes at the time of transfer. By transferring the carbon nanotube forest 12 in this manner, the surface of the carbon nanotube forest 12 in contact with the substrate 13 can be moved onto the surface of the carbon nanotube forest laminated body 1 without damaging the forest.

In the method of producing a carbon nanotube forest laminated body according to the embodiment illustrated in FIG. 3A and FIG. 3B, the substrate 13 on which the carbon nanotube forest 12 is provided can be, for example, a silicon substrate such as silicon wafers in addition to the metal substrate described above.

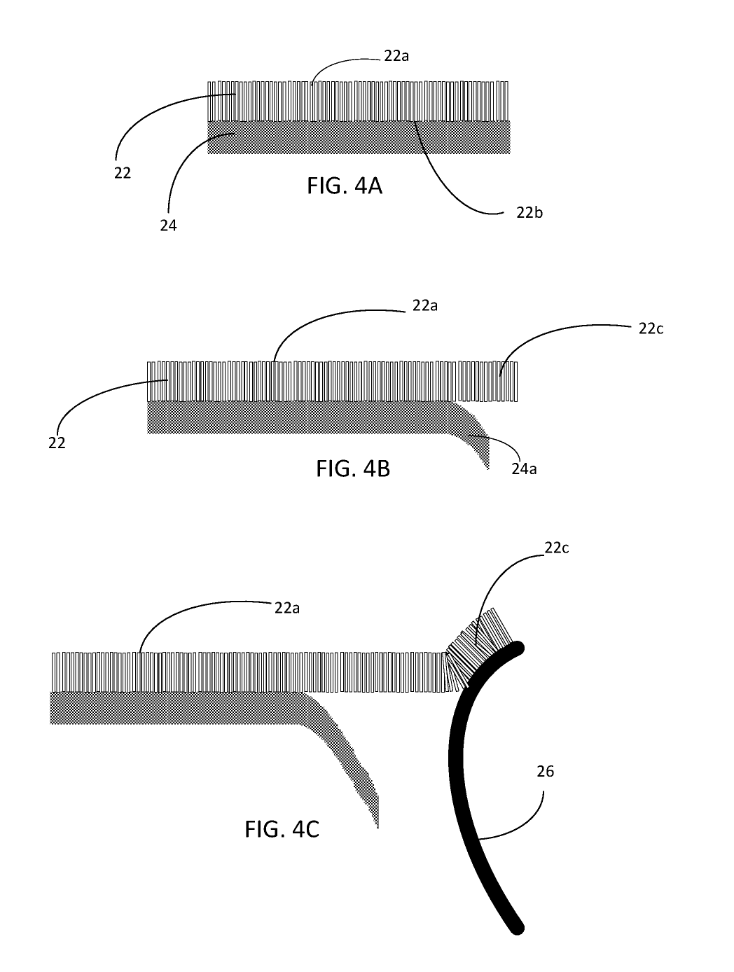

In FIGS. 4A through 4D, a method is illustrated where a nanofiber forest is transferred to a second substrate while maintaining the orientation of the forest. In this case, the proximal surface 22b of the forest, which is in contact with the growth substrate 24, is transferred to the surface of second substrate 26. To accomplish this, an edge 24a of stainless steel growth substrate 24 is peeled down to produce overhanging edge 22c of nanofiber forest 22. The overhanging edge 22c is contacted with flexible, adhesive second substrate 26 so that proximal surface 22b of nanofiber forest 22 is adhered to second substrate 26. As stainless steel substrate 24 is continuously peeled away from forest 22 as shown in FIG. 4C, second substrate 26 (e.g., PET sheet) is advanced upwardly to capture the forest as it is released from stainless steel substrate 24. As shown in FIG. 4D, eventually all of the forest is transferred from stainless steel substrate 24 to secondary substrate 26. Note that surface 22b, formerly in contact with stainless steel substrate 24 is now in direct contact with adhesive substrate 26. This is in contrast to the method of FIGS. 3A and 3B where the exposed, opposing side of the forest is adhered to the secondary substrate. Thus, methods described herein can be used to transfer forests to second substrates either with or without flipping the orientation of the forest. Furthermore, these methods of production provide for the transfer of the forest from one substrate to another regardless of the surface characteristics of the growth substrate.

As described above, the embodiment allows the support 11 to have an appropriate adhesive strength range with respect to the carbon nanotube forest 12 because the carbon nanotube forest 12 is provided on the surface Ila of the support 11 having an adhesive strength of greater than 0.01 N/25 mm and less than 2 N/25 mm. In this manner, the carbon nanotube forest laminated body 1 can prevent the carbon nanotube forest 12 from separating from the surface 11a of the support 11 and enables easy drawing of a carbon nanotube sheet from the carbon nanotube forest 12 supported on the support 11. In addition, the carbon nanotube forest 12 can be shifted onto a support 11 having an intended size, and thus a carbon nanotube sheet having an intended size can be easily obtained.

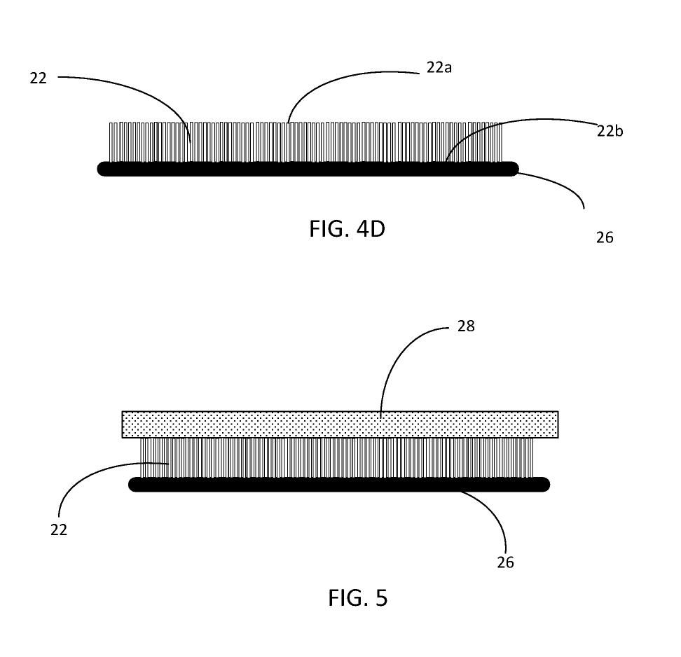

FIG. 5 provides a cutaway view of another embodiment used to protect a nanofiber forest attached to a substrate such as an adhesive or an adhesive sheet. Release sheet 28 can be applied to the exposed surface of the forest 22, forming a sandwich of nanofibers with an adhesive sheet 26 on one side and a release sheet 28 on the opposed side. As shown, the release sheet is not in contact with the adhesive. Release sheet 28 can have low or very low adhesive strength and can be, for example, a silicone treated material such as a silicone release sheet. The release sheet can protect the forest from dirt, dust, moisture, etc. It can also allow the forests to be wound into rolls providing for much more efficient storage and transport of nanofiber forests, such as carbon nanotube forests. Rolls can be wound with either release sheet 28 or adhesive substrate 24 facing inwards. In this manner, many square meters of nanofiber forest can be stored in a roll one meter long and 10 cm in diameter. Prior to drawing the forest into sheets, ribbons or yarns, the release sheet can be removed, exposing the nanofiber forest for drawing off of the adhesive layer. Large rolls can provide a continuous supply of nanofiber forests for continuous drawing operations.

### Sheet Drawing Techniques

Different techniques can be used to draw carbon nanotube sheets from a forest. In one set of embodiments, a continuous, transparent nanotube sheet having high strength can be drawn from a carbon nanotube forest, such as a multi-walled carbon nanotube (MWCNT) forest, on a support having an adhesive strength of 0.01 N/25 mm or more and 2 N/25 mm or less using the method described in W02007/015710. Thus, draw can be initiated using an adhesive strip to contact MWCNTs teased from the forest sidewall. Contact by an adhesive tape to either the top or sidewall (edge) of the nanotube forest is useful for providing the mechanical contact that enables the start of sheet draw. Various adhesive types worked well for initiating sheet draw, including the adhesive attached to a 3M Post-it Note, Scotch Transparent Tape (600 from 3M), Scotch Packaging Tape (3M 3850 Series), and Al foil duct tape (Nashua 322). Contact of a straight adhesive strip (so that the adhesive strip is orthogonal to the draw direction) worked especially efficiently to start the draw of a high structural perfection sheet. The reason that this top contact method is especially advantageous is that nanotube forests typically have non-straight sidewalls, and the use of a straight adhesive strip provides straight contact for the forest draw.

An array of closely spaced pins can also be employed to start sheet draw from a nanofiber forest on the adhesive support described above. For example, a pin array consisting of a single line of pins can be used. The mechanical contact can be initiated by partial insertion of the linear pin array into the nanotube forest. As a specific example, the pin diameter can be 100 micron, the pin tip can be less than one micron, and the spacing between the edges of adjacent pins can be less than a millimeter. Satisfactory sheet draw can be achieved using pin penetration of between ⅓ and ¾ of the height of the forest (for instance, between 200 and 300 microns).

Meter-long sheets, for example, up to 5 cm wide, can be made at a meter/minute by hand drawing. Despite a measured areal density of only approximately 2.7 μg/cm², resulting 500 cm² sheets are self-supporting during draw. It is possible for a one centimeter length of 245 um high forest supported on a support having an adhesive strength of 0.01 N/25 mm or more and 2 N/25 mm or less to be converted to about a three-meter-long free-standing MWCNT sheet, and this is made easier since the adhesive nature of the sheet keeps the nanotubes upright. Sheet production rates can be further increased using an automated linear translation stage to accomplish draw at up to 10 m/min by winding the sheet on a rotating cm-diameter plastic cylinder. The sheet fabrication process is quite robust and no fundamental limitations on sheet width and length are apparent since the nanotubes are prevented from falling on the support due to its adhesiveness. The nanotubes remain highly aligned on the support and also in the sheet in the draw direction.

Ribbons, ribbon arrays, yarns, or yarn arrays may also be more easily drawn from a nanotube forest supported on a support having an adhesive strength of 0.01 N/25 mm or more and 2 N/25 mm or less. For example, the width of the nanofiber sheet can be optionally increased or decreased to ribbon type widths. This can be optionally accomplished by controlling the width of the nanotube forest sidewall (or other pre-primary nanofiber assembly) that is contacted when ribbon draw is initiated, patterning forest deposition, or by separating wide drawn sheets into ribbons (such as by mechanical or laser-assisted cutting). The ribbon width can be, for example, least 0.5 mm. In other embodiments, the ribbon width is greater than one millimeter.

### EXAMPLES

The present invention will next be described in detail on the basis of examples and comparative examples that were carried out in order to demonstrate advantageous effects of the invention. The present invention is not intended to be limited to the following examples and comparative examples.

### Adhesion Evaluation of Carbon Nanotube Forest

After formation of a CNT forest formed on a support such as a silicon wafer, a mixed gas of dimethyl ether and carbon dioxide was blown through a dust blower across the forest, and the substrate was examined for evidence of the separation of carbon nanotubes from the substrate. Evaluation criteria are illustrated below. Results are provided in Table 1.

No noticeable carbon nanotubes removed. ∘:

Noticeable loss of carbon nanotubes. ×:

### Drawing Characteristics Evaluation of Carbon Nanotube Sheet

To evaluate whether or not a particular forest could be drawn into a sheet, an end of a carbon nanotube forest was twisted and drawn with tweezers to form a carbon nanotube sheet, and the resulting sheet was evaluated. Evaluation criteria are illustrated below and are reported in Table 1.

A continuous carbon nanotube sheet was formed smoothly. ∘:

A carbon nanotube sheet was broken and/or failed to form a usable sheet. ×:

### Example 1

A thermal CVD system with three furnaces containing argon gas as a carrier gas and acetylene as a carbon source were used to form a carbon nanotube forest on a metal substrate (stainless steel plate) through catalytic chemical vapor deposition. The carbon nanotube forest had a height of 300 μm.

Subsequently, the metal substrate as the substrate on which the carbon nanotube forest had been formed was bent from an end, and an end portion of the carbon nanotube forest was peeled off. The peeled portion was shifted from the end onto an adhesive sheet (product name: ASD38-J1525, manufactured by Lintec Corporation) as the support, forming a carbon nanotube forest laminated body. The adhesive sheet had an adhesive strength of 0.03 N/25 mm, which was determined in accordance with JIS Z0237:2000.

In this example, the carbon nanotube forest was easily shifted from the metal substrate onto the adhesive support. The adhesive sheet had an adhesive strength of greater than or equal to 0.01 N/25 mm and less than or equal to 0.5 N/25 mm. In the adhesion test no carbon nanotubes were separated from the support. In the drawing test, the drawing characteristics were good and quality sheets could be drawn.

### Example 2

A carbon nanotube forest laminated body was produced and evaluated in the same manner as in Example 1 except that an adhesive sheet (product name: ASD38-JK1525, manufactured by Lintec Corporation) was used as the support. The adhesive sheet had an adhesive strength of 0.07 N/25 mm. In the adhesion test no carbon nanotubes were separated from the support. In the drawing test, the drawing characteristics were good and quality sheets could be drawn.

### Example 3

A carbon nanotube forest laminated body was produced and evaluated in the same manner as in Example 1 except that an adhesive sheet (product name: ASB38-K2025, manufactured by Lintec Corporation) was used as the support. The adhesive sheet had an adhesive strength of 0.06 N/25 mm. In the adhesion test no carbon nanotubes were separated from the support. In the drawing test, the drawing characteristics were good and quality sheets could be drawn.

### Reference Example 1

A carbon nanotube forest laminated body was produced in the same manner as in Example 1 except that a carbon nanotube forest was formed on a quarter of a 6-inch silicon wafer in place of the metal substrate. In Reference Example 1, the carbon nanotube forest was not released from the silicon wafer, and the carbon nanotube forest was not able to be transferred onto the support because no metal substrate was used.

### Comparative Example 1

A carbon nanotube forest was formed on a support in the same manner as in Example 1 except that an adhesive layer that had a thickness of 30 um and had been prepared by applying an acrylic adhesive (product name: PA-T1, manufactured by Lintec Corporation) onto a polyethylene sheet having a thickness of 50 um as a base material was used as the adhesive sheet. The adhesive sheet of Comparative Example 1 had an adhesive strength of 16 N/25 mm, which was determined in accordance with JIS Z0237:2000. In Comparative Example 1, the CNT forest did not separate during the adherence test because a high adhesive strength was used when the carbon nanotube forest was transferred to the support. However, the carbon nanotube sheet was not able to be drawn because the sheet had an excessively high adhesive strength, and the nanotubes could not be drawn into sheets.

### Comparative Example 2

The carbon nanotube forest formed on the silicon wafer in Reference Example 1 was not shifted or transferred to a support, and was subjected to the adherence evaluation of the carbon nanotube forest and the evaluation of drawing characteristics of the carbon nanotube sheet. As a result, a carbon nanotube sheet was able to be drawn from the silicon wafer, but the carbon nanotubes separated from the silicon wafer and did not pass the adhesion test.

TABLE l

| | Adhesive strength | | |
|---|---|---|---|
| | of support | | Drawing |
| | (N/25 mm) | Adhesion Test | Characteristics |
| Example 1 | 0.03 | ∘ | ∘ |
| Example 2 | 0.07 | ∘ | ∘ |
| Example 3 | 0.06 | ∘ | ∘ |
| Comparative | 16 | ∘ | x |
| Example 1 | | | |
| Comparative | — | x | ∘ |
| Example 2 | | | |

As listed in Table 1, both the adhesion evaluation and the evaluation of drawing characteristics were good in the cases in which a carbon nanotube forest was provided on the surface of the support having an adhesive strength of 0.01 N/25 mm or more and 2 N/25 mm or less (see Examples 1 to 3). The result indicates that the support having an appropriate adhesive strength range with respect to the carbon nanotube forest prevents the carbon nanotube forest from separating from the support and also enables easy drawing of the carbon nanotube sheet from the carbon nanotubes adhered to the support.

In contrast, it is recognized that the adhesion evaluation was good but the evaluation of drawing characteristics was poor when the adhesive strength was more than 2 N/25 mm (see Comparative Example 1). In these cases, the excessively high adhesive strength of the support made it difficult to draw the sheets. It is also recognized that the drawing characteristics were good but the adhesion evaluation was poor in the case in which the carbon nanotube forest was not provided on the surface of a support having a predetermined adhesive strength range (see Comparative Example 2). The result is inferred from a fact that the carbon nanotubes separated from the support due to insufficient adhesiveness between the carbon nanotube and the support.

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

1. A carbon nanotube forest laminated body comprising:
a support having an adhesive surface; and
a carbon nanotube forest provided on the surface of the support, the surface of the support having an adhesive strength of greater than or equal to 0.01 N/25 mm and less than or equal to 2 N/25 mm.

2. The carbon nanotube forest laminated body according to claim 1, wherein the support is a self-adhesive sheet.

3. The carbon nanotube forest laminated body according to claim 1, wherein the support is an adhesive sheet comprising a base material and an adhesive layer provided on the base material.

4. The carbon nanotube forest laminated body according to claim 3, wherein the base material is a resin film.

5. The carbon nanotube forest laminated body of claim 1 wherein the adhesive strength of the support is greater than the adhesive force between the forest and the growth substrate on which the carbon nanotube forest was grown.

6. The carbon nanotube forest laminated body of claim 1 wherein the forest has a proximal surface which was formerly in contact with a growth substrate and a distal surface which was opposed to the surface of the growth substrate, and the proximal surface is attached to the adhesive surface.

7. The carbon nanotube forest laminated body of any of claim 1 wherein the forest has a proximal surface which was formerly in contact with a growth substrate and a distal surface which was opposed to the surface of the growth substrate, and the distal surface is attached to the adhesive surface.

8. The carbon nanotube forest laminated body of any of claim 1 further comprising a release sheet on the surface of the forest that faces away from the support.

9. A carbon nanotube sheet drawn from the carbon nanotube forest laminated body of claim 1.

10. A method of producing a carbon nanotube forest, the method comprising:
shifting a carbon nanotube forest from a substrate on which the carbon nanotube forest is provided onto a surface of a support, the surface having an adhesive strength of 0.01 N/25 mm or more and 2 N/25 mm or less.

11. The method of claim 10 wherein the surface has an adhesive strength of greater than or equal to 0.015 N/25 mm, greater than or equal to 0.025 N/25 mm, greater than or equal to 0.04 N/25 mm, greater than or equal to 0.05 N/25 mm.

12. The method of claim 10 wherein the forest has a proximal surface which is in contact with substrate prior to shifting and is in contact with the support after shifting.

13. The method of claim 10 wherein the forest has a proximal surface which is in contact with substrate prior to shifting and is in contact with the support after shifting.

14. The method of claim 10 wherein the forest has a proximal surface which is in contact with substrate prior to shifting and an opposed distal surface that is in contact with the support after shifting.

15. The method of claim 10 further comprising drawing a carbon nanotube sheet from the nanotube forest on the support.

16. The method of claim 10 further comprising transporting the nanotube forest on the surface of the support and subsequently drawing a sheet from the nanotube forest.

17. The method of any of claim 10 further comprising placing a release sheet on the surface of the nanotube forest that is opposed to the support.
